(19) United States
(12) Patent Application Publication
(10) Pub. No.: US 2004/0046049 A1
(43) Pub. Date: Mar. 11, 2004

(54) Apparatus for containing spray

(76) Inventors: Michael A. Ricciardelli, Groton, MA (US); Robert J. Buonopane, Groton, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/228,485

(22) Filed: Aug. 27, 2002

(51) Int. Cl. B05B 1/28

(52) U.S. Cl. 239/288

(57) ABSTRACT

Described is an apparatus for containing the spray released from the nozzle of a spray applicator. The apparatus includes a chamber having a sidewall and a spray end. The sidewall has a first opening shaped to receive the spray applicator and a second opening for accessing the nozzle within the chamber. Alternatively, the sidewall has a single opening shaped to receive the spray applicator and for accessing the nozzle. The spray end is positioned to receive an overspray from the nozzle. The apparatus can include an overspray absorber at the spray end to reduce or eliminate any excess liquid resulting from overspray during spraying.

### FIELD OF THE INVENTION

The invention relates generally to an apparatus for applying a spray to an object. More particularly, the invention relates to a chamber for limiting the dispersion of the spray during application of the spray to the object.

### BACKGROUND

Fishing enthusiasts experiment with various lures and baits in order to increase the likelihood of catching fish. Because many fish respond to odor, one technique that is often successful includes applying a strongly scented liquid to the fishing lure. The applied liquid can include the scent of garlic, crawfish, menhaden, crab, shrimp, among others, or any other odor that attracts fish. Scented liquids are typically concentrated to improve the effectiveness of the technique. For example, the scented liquid may be an oil-based formulation. Scented liquids are commercially available in aerosol spray applicators that can be used to spray the lure and then stored for later use.

Fishermen frequently use several lures during a fishing expedition for a variety of reasons. For instance, a lure can be lost from the fishing line or the fisherman desires to change from one lure to another in the belief that the new lure is more likely to attract fish. Consequently, the fisherman sprays the new lure to improve its effectiveness. Environmental conditions, especially wind, present a problem for this process. Often the fisherman is in a moving boat, surfcasting, or in a location where wind disperses the scented spray. As a result the spray can coat the boat, clothing or even the exposed skin of the fisherman or a nearby person. Overspray can occur without the presence of wind. Due to the particulate size and the type of liquid (e.g., an oil-based liquid) used to carry the scent, the resulting stains and odor may be difficult to remove even with repeated cleaning attempts.

One technique to limit the dispersion of excess spray, or overspray, involves placing the lure in a large flexible and disposable wrapper such as a commercially available plastic sandwich bag. The fisherman places the lure inside the bag and then reaches into the bag with a spray applicator to coat the lure with the scented spray. The bag opening is large and permits a portion of the overspray to escape. Also, the bag and the spray applicator are unwieldy to handle, requiring the fisherman to use one hand to hold the bag and lure and the other hand to apply the spray. Furthermore the fisherman can come in contact with the spray residue inside the bag when reaching in to retrieve the lure.

Therefore, there remains a need for a spray containment apparatus that is simple to use and avoids the aforementioned problems.

### SUMMARY

In one aspect, the invention features an apparatus for containing a spray released from the nozzle of a spray applicator and directed at an object. The apparatus includes a chamber having a sidewall and a spray end at which the object is situated. The sidewall has an opening shaped for receiving the spray applicator and for accessing the nozzle when the spray applicator is disposed in the opening. The spray end is positioned relative to the opening to receive an overspray from the nozzle. In one embodiment, the apparatus includes an overspray absorber disposed adjacent to the spray end. In another embodiment, the apparatus includes the spray applicator.

In another aspect, the invention features an apparatus for containing a spray released from a nozzle of a spray applicator and directed at an object. The apparatus includes a chamber having a sidewall and a spray end at which the object is situated. The sidewall has a first opening shaped to receive the spray applicator and a second opening for accessing the nozzle when the spray applicator is disposed in the first opening. The spray end is positioned relative to the first opening to receive an overspray from the nozzle. In one embodiment, the apparatus includes an overspray absorber disposed adjacent to the spray end. In another embodiment, the apparatus includes the spray applicator.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is an illustration of an embodiment of a spray containment apparatus in accordance with the present invention.

FIG. 2A is an exploded view of the spray containment apparatus of FIG. 1.

FIG. 2B is an exploded view of another embodiment of a spray containment apparatus in accordance with the present invention.

FIG. 3A is an illustration of another embodiment of a spray containment apparatus in accordance with the present invention.

FIG. 3B is a cross-sectional view of the extended tubular section of the spray containment apparatus of FIG. 3A.

FIG. 3C is an illustration of another embodiment of a spray containment apparatus in accordance with the present invention.

### DETAILED DESCRIPTION

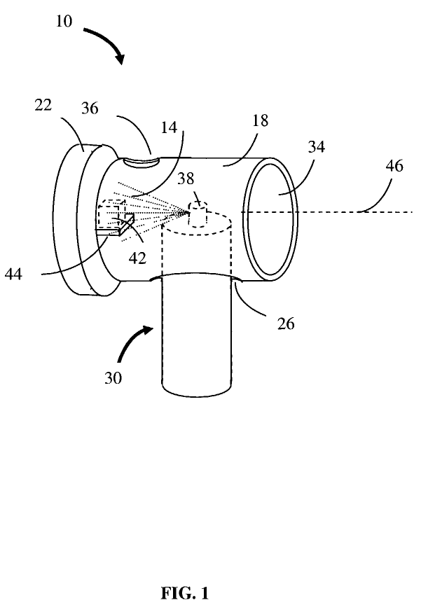

FIG. 1 is an illustration of an embodiment of an apparatus for containing the spray released from a spray applicator constructed in accordance with the present invention. The apparatus 10 includes a chamber defined by a sidewall 18 and an endcap 22. The sidewall includes a first opening 26 to accept a spray applicator 30 and a second opening 34 (called an access opening) at one end of the chamber to permit the user to insert one or more fingers into the chamber and access the nozzle 38 of the spray applicator 30. Because the apparatus 10 is constructed from lightweight materials, a person can use the apparatus 10 to quickly spray a wide variety of objects with ease, provided the apparatus 10 is appropriately sized for the particular object being sprayed. Examples of objects include, but are not limited to, fishing lures, brake calipers, jewelry, and Easter eggs.

The apparatus 10 accommodates aerosol spray cans and other pressurized applicators that can be introduced into the chamber through the applicator opening 26. Thus the apparatus 10 is useful for applying a wide range of substances such as, but not limited to, scented oils (e.g., bait sprays, perfumes), paint, cleaning fluids, solvents, and spray adhesives, while significantly limiting the dispersion of any overspray.

The endcap 22 covers an opening at the spray end of the chamber (i.e., the end opposite the access opening 34). The object 42 to be sprayed (e.g., a fishing lure) is positioned at the spray end of the chamber adjacent the endcap 22. In one embodiment, the object 42 rests on a spray shelf 44 that is positioned in the path of the nozzle 38. The spray shelf 44 can extend from an interior surface of the endcap 22 or from an interior surface of the sidewall 18. Overspray, that is, the portion of the spray 14 that is not deposited on the object 42, is collected by an absorber (not shown) disposed in the endcap 22.

In one embodiment, the endcap 22 has a flat outer surface that permits the user to stand the apparatus 10 on end. Thus, the user can set the apparatus 10 down on a flat surface after finishing spraying. The spray applicator 30 can remain inserted in the opening 26 because the opening 26 is sized to closely receive the spray applicator 30. Subsequently, the user can pick the apparatus 10 up by the spray applicator 30 to perform another spraying.

Optionally, the sidewall 18 includes a third opening 36 through which the user can insert the object 42 into the chamber at the spray end. In embodiments with a spray shelf 44, the third opening 36 is positioned above the spray shelf 42 so that the user can lower the object 42 directly onto the spray shelf 44. If the object 42 is a fishing lure at the end of fishing line, the third opening 36 simplifies use of the apparatus by providing a means of inserting the object 42 into the chamber without putting kinks in the fishing line, wrapping the fishing line around the exterior of the sidewall 18, or interfering with the user's access to the nozzle 38, which may occur if the user inserts the object 42 through an opening at the spray end made by removing the endcap, through the opening 26 for the spray applicator 30, or through the access opening 34.

Use of the apparatus 10 is particularly advantageous in the presence of wind or in poorly ventilated or unventilated areas. To use the apparatus 10, a person places the object 42 to be sprayed inside the chamber near the endcap 22 through any of the openings 26, 34, 36 described above. The spray applicator 30 is inserted through the applicator opening 26 in the sidewall 18 so that the nozzle 38 is situated in the chamber approximately on the axis 46 of the sidewall 18. The spray applicator 30 is rotated so that the spray from the nozzle 38 is directed towards the object 42 and the endcap 22. To spray the object 42, the user reaches through the access opening 34 and depresses the nozzle 38. After spraying is completed, the spray applicator 30 is removed from the chamber. The user then retrieves the object 42 from the chamber through the access opening 34. If, for example, the sprayed object 42 is a fishing lure attached to a fishing line, the user removes the lure by pulling on the fishing line remaining outside the chamber. In this way the user does not come in contact with the sprayed lure. In one embodiment the endcap 22 is removable thus the user can load the object 42 into the chamber and/or remove the object 42 from the chamber through the opening at the spray end of the chamber.

Another way to use the apparatus 10 is to stand the apparatus 10 on end or to position the apparatus 10 so that that the opening 26 is facing upwards, insert the object 42 into the chamber, and then pour the “spray” onto the object 42. The apparatus 10 can then be left for a prolonged period to allow the object 42 to soak in the spray.

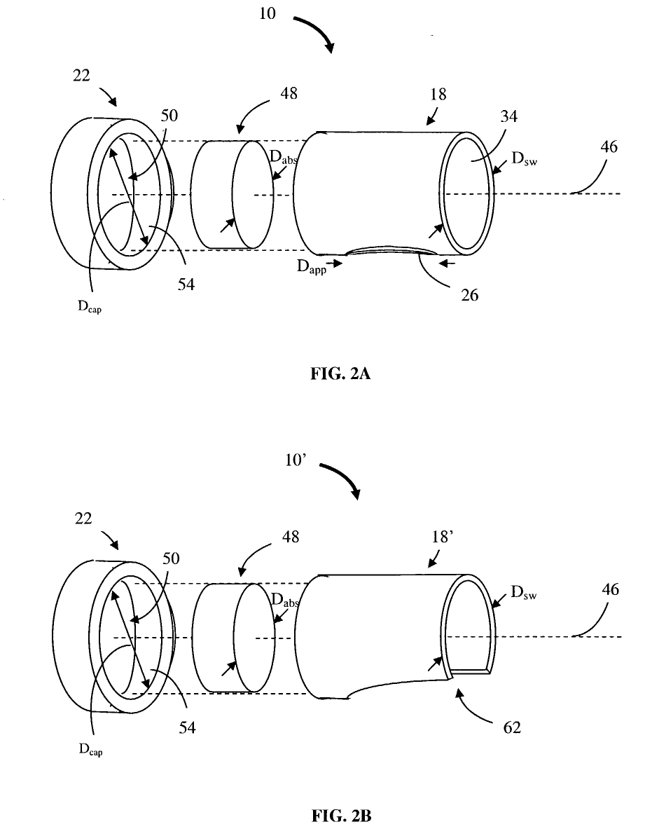

FIG. 2A shows an exploded view of the spray containment apparatus 10 of FIG. 1. The apparatus 10 includes the endcap 22, an overspray absorber 48 and the sidewall 18. The sidewall 18 and endcap 22 are fabricated, for example, from polyvinyl chloride (PVC) which can be obtained in unfinished form from plumbing supply vendors. The resulting light weight of the apparatus 10 permits the user to use the apparatus 10 with only one hand (typically by the spray applicator). The endcap 22 includes a recessed region 50 of diameter Deap that is slightly larger than the outer diameter D_{SW} of the sidewall 18. In one embodiment the endcap 22 is removably attached to the sidewall 18 by a pressure fit. In another embodiment, the endcap 22 is permanently secured to the sidewall 18 with the use of an adhesive. In an alternative embodiment, (not shown) the inner wall 54 of the endcap 22 and a portion of the sidewall 18 are threaded. The endcap 22 thus is easily unscrewed from the sidewall 18 to provide additional access to the chamber.

Excess spray that does not coat or is not absorbed by the object 42 is usually deposited on the endcap 22 or sidewall 18 of the chamber. The overspray can accumulate as excess fluid within the chamber and potentially contact the user during subsequent use of the apparatus 10. The overspray absorber 48 provides a convenient means to absorb the excess spray and reduce or eliminate the excess fluid. The absorber 48 is replaced after each spraying or after it is saturated. If the sprayed object is a fishing lure, the absorber 48 can be used many times before replacement is necessary because a scant amount of spray is needed to adequately scent the lure. In the illustrated embodiment the overspray absorber 48 is a disk of absorbent material. The diameter D_{abs} of the disk is approximately equal to the outer diameter D_{SW} of the sidewall 18. In one embodiment the overspray absorber 48 is fabricated from an inexpensive porous material such as a sponge and is press fit into a recessed region 50 of the endcap 22.

The diameter Dₐₚₚ of the sidewall opening 26 for the spray applicator 30 is slightly larger than the cylindrical diameter of the spray applicator 30 (see FIG. 1) to minimize any gap through which excess spray can escape. In one embodiment the sidewall 18 includes a gasket or flexible member secured to the opening 26 to reduce or eliminate this gap.

It should be recognized by those of skill in the art that the geometry of the chamber is not limited to a tubular configuration defined by the sidewall 18 of the illustrated embodiment described above. For example, the chamber can be defined by a cylinder having a bore along its longitudinal axis. One end of the chamber is closed and the other end is open (opening 62). In this configuration there is no need for an endcap 22. More generally, the chamber can have any arbitrary shape that has one or more openings that permit introduction of the spray applicator 30 into the chamber and access to the spray nozzle 38.

In the embodiment shown in FIG. 2B, the spray containment apparatus 10′ includes a sidewall 18′ with the single opening 62 sized to receive the spray applicator 30 and provide access for the user. The opening 62 tapers near the end pointed to by the arrow 62. At the tapered end, the opening 62 is narrower than the diameter of the spray applicator 30. The tapering limits the extent to which the spray applicator 30 can move laterally within the opening 62 after being inserted from below into the chamber because the spray applicator 30 is unable to slide through the tapered end. The spray containment apparatus 10′ can be set on a flat surface, with an edge of the endcap 22 and an edge of the spray applicator 30 resting on the surface, without the spray applicator 30 coming out of the opening 62 and becoming separated from the apparatus 10′.

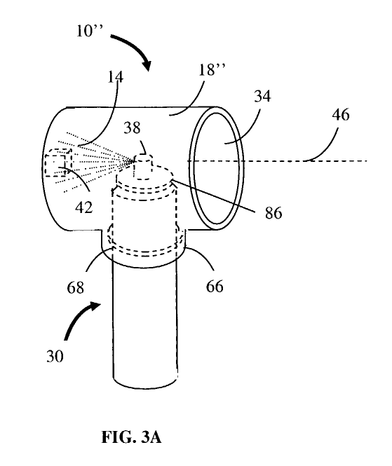

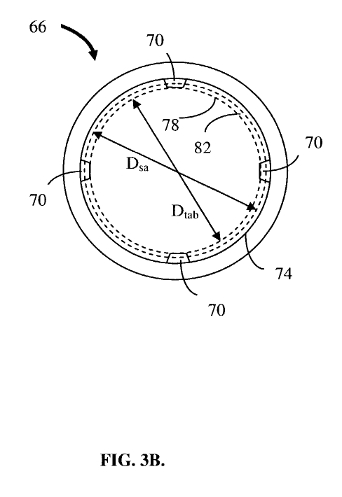

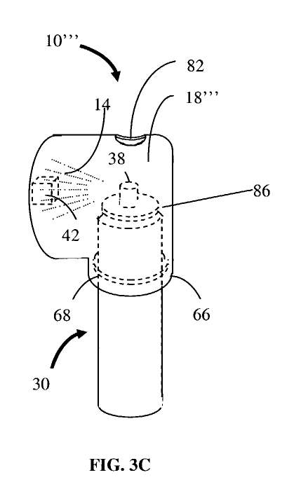

FIG. 3A shows another embodiment of an apparatus 10″ for containing the spray 14 released from a spray applicator 30. The apparatus 10″ includes the general features of the embodiment of FIG. 1, however, no endcap is required because the sidewall 18″ forms a closed end at the spray end of the chamber. Also, the applicator opening 26 is modified to serve as an applicator attachment port for securing the spray applicator 30 to the sidewall 18″. This allows the user the convenience of operating the apparatus 10″ with one hand and the ability to rest the combined applicator 30 and apparatus 10″ on a flat surface when not in use. In the illustrated embodiment the applicator attachment port is fabricated in the sidewall 18″ as an extended tubular section 66 oriented perpendicular to the sidewall axis 46. Many commercially available spray applicators 30 (e.g., aerosol cans) have general cylindrical shapes and include one or more circumferential ridges 68 near the nozzle 38 for securing a cap onto the applicator 30. For example, commercially available spray applicators of varying diameters have a “universal ring” (ring 86 in FIG. 3A) with a standardized diameter (e.g., 1¼ inches). This ridge or ridges 68 or universal ring 86 can be used to secure the applicator 30 in the extended tubular section 66.

Referring also to FIG. 3B, a cross-sectional view of the extended tubular section 66 shows a set of circumferentially configured tabs 70 along its inner wall 74. The tabs 70 define a circular shape 78 of diameter D_{tab} that is slightly smaller than the diameter Dₛₐ of the circumferential ridge 68 of the spray applicator 30. The extended tubular section 66 has sufficient flexibility so that the spray applicator 30 is “locked” into the proper position for spraying when the applicator 30 is inserted so that its circumferential ridge 68 “snaps” past the tabs 70. In one embodiment the extended tubular section 66 includes a second set of circumferentially distributed tabs 70 along the inner wall 74. The spray applicator 30 is secured in place when the circumferential ridge 68 is positioned between the two sets of tabs 70. In another embodiment (not shown) the applicator 30 is screwed into the extended tubular section 66. In this embodiment the inner wall 74 of the extended tubular section 66 is threaded to accept the circumferential ridge 68.

Many other designs are possible for the applicator attachment port. For example, if the sidewall is sufficiently thick, tabs or other features can be integrated directly into the sidewall opening without the need for the extended tubular section 66. One of ordinary skill will recognize that various other mechanical designs to secure the spray applicator 30 to the sidewall 18″ of the chamber without departing from the scope of the present invention.

FIG. 3C illustrates another embodiment of a spray containment apparatus 10′″. The apparatus 10′″ includes the general features illustrated in the embodiment of FIGS. 3A and 3B, however, there is no large access opening in the sidewall 18′″. Instead, the sidewall 18′″ is in the form of a cap (hereafter, cap 18′″) that snaps onto to the ridge 68 or the universal ring 86 of the spray applicator 30, as described above. The cap is an integral unit, that is, the cap is made of a single piece of material, for example, plastic. A user can remove any cap that comes originally with the spray applicator 30 and substitute the cap 18′″ of the invention. This substitution is facilitated by sizing the cap 18′″ to attach to the standardized universal ring 86 or to the ridge 68 with a particular diameter. Alternatively, a distributor of the spray applicator 30 can provide spray applicators 30 with the cap 18′″ already attached.

Access to the chamber is provided through a small opening 82 at or near the top of the cap 18′″ above the nozzle 38. The user loads and unloads the object 42 to be sprayed by removing the cap 18′″ and loading the object 42 through the applicator opening (not shown). The small opening 82 is sized to allow a finger to reach into the chamber and depress the nozzle 38. In this configuration the spray escaping the chamber is further reduced. In an alternative embodiment, the size of the opening 82 is increased so that the object 42 can be loaded through the opening 82 when the cap 18′″ is attached to the applicator 30.

In another embodiment, the cap 18′″ includes another opening (not shown), near the spray end, at the top or in one side of the cap 18′″, for inserting the object 42. During the spraying of the object 42, a hinged flap can partially or completely close the opening after insertion of the object 42 into the chamber to lessen the amount of overspray that escapes the chamber.

While the invention has been shown and described with reference to specific preferred embodiments, it should be understood by those skilled in the art that various changes in form and detail may be made therein without departing from the spirit and scope of the invention as defined by the following claims.

What is claimed is:

1. An apparatus for containing a spray released from a nozzle of a spray applicator and directed at an object, the apparatus comprising a chamber having a sidewall and a spray end at which the object is situated, the sidewall having an opening shaped for receiving the spray applicator and for accessing the nozzle within the chamber when the spray applicator is disposed in the opening, the spray end being positioned relative to the opening to block an overspray from the nozzle.

2. The apparatus of claim 1, further comprising an overspray absorber disposed substantially adjacent to the spray end to absorb the overspray.

3. The apparatus of claim 1, further comprising the spray applicator.

4. The apparatus of claim 1, wherein a portion of the opening is shaped to closely receive the spray applicator.

5. The apparatus of claim 1, wherein the sidewall attaches to the spray applicator at the opening.

6. The apparatus of claim 1, wherein the sidewall is fabricated from a polyvinyl chloride material.

7. The apparatus of claim 1, further comprising a spray shelf within the chamber at the spray end for supporting the object in a path of the spray from the nozzle.

8. The apparatus of claim 1, wherein the sidewall has another opening at the spray end through which the object can be inserted into the chamber.

9. The apparatus of claim 1, wherein the object is a fishing lure.

10. An apparatus for containing a spray released from a nozzle of a spray applicator and directed at an object, the apparatus comprising a chamber having a sidewall and a spray end at which the object is situated, the sidewall having a first opening shaped for receiving the spray applicator and a second opening for accessing the nozzle within the chamber when the spray applicator is disposed in the first opening, the spray end being positioned relative to the first opening to block an overspray from the nozzle.

11. The apparatus of claim 10, further comprising an overspray absorber disposed substantially adjacent to the spray end to absorb the overspray.

12. The apparatus of claim 10 further comprising the spray applicator.

13. The apparatus of claim 10, wherein the sidewall attaches to the spray applicator at the first opening.

14. The apparatus of claim 10 wherein the sidewall is fabricated from a polyvinyl chloride material.

15. The apparatus of claim 10, further comprising a spray shelf within the chamber at the spray end for supporting the object in a path of the spray from the nozzle.

16. The apparatus of claim 10, wherein the sidewall has a third opening at the spray end through which the object can be inserted into the chamber.

17. The apparatus of claim 10, wherein the object is a fishing lure.
